(19) United States
(12) Patent Application Publication
(10) Pub. No.: US 2021/0191708 A1
(43) Pub. Date: Jun. 24, 2021

(54) Vehicle and Electrical Device for Vehicle

(71) Applicants: Hyundai Motor Company, Seoul (KR); Kia Motors Corporation, Seoul (KR)

(72) Inventor: Yoonseok Yang, Yongin-si (KR)

(21) Appl. No.: 17/080,469

(22) Filed: Oct. 26, 2020

(30) Foreign Application Priority Data
Dec. 18, 2019 (KR) 10-2019-0169660

(51) Int. Cl. G06F 8/65; B60R 16/023; B60W 50/06

(52) U.S. Cl. CPC G06F 8/65; B60W 50/06; B60R 16/0231

(57) ABSTRACT

A vehicle includes at least one electrical device, and a communication device configured to communicate with a server, receive a software update data, and provide the software update data to the at least one electrical device, wherein the electrical device includes a communication interface configured to receive the software update data from the communication device, a memory configured to store a software component, and a processor configured to update the software component using the software update data, and wherein a storage area in which the software component is stored and a reserved area allocated to the software component are alternately arranged in the memory.

### CROSS-REFERENCE TO RELATED APPLICATIONS

This application claims priority to Korean Patent Application No. 10-2019-0169660, filed in the Korean Intellectual Property Office on Dec. 18, 2019, which application is hereby incorporated herein by reference.

### TECHNICAL FIELD

The present disclosure relates to a vehicle and an electrical device for a vehicle.

### BACKGROUND

In general, a vehicle is a moving means or a transportation means that travels on a road or a line using fossil fuels, electricity, or the like as a power source.

Recently, vehicles have moved beyond simply transporting goods and personnel, with audio and video devices, allowing drivers to listen to music and watch images while driving, and navigation devices that display a route to a driver's destination also being widely installed in vehicles.

As such, the vehicle is provided with various electrical devices. The vehicle is equipped with an engine management system (EMS), a transmission control unit (TCU), and electronics stability control (ESC), as well as convenience devices such as audio devices, video devices, and navigation devices, and an electrical device (driving device) related to driving of the vehicle, such as a motor driven power steering (MDPS).

Various electrical devices include hardware and software for controlling various electrical devices. The electrical device of the vehicle may be updated to correct an error of the electrical device, to improve the performance of the electrical device, to add a new function of the electrical device, and the like. At this time, the hardware is difficult to update other than reinstallation or replacement. Thus, the update of the electrical device can be achieved mainly using the update of software.

Updates of the software can be accomplished using a wireless network for the convenience of the driver.

In addition, the updating of the software is performed by updating all the software included in the electrical device to be updated. For example, when updating software related to the control of the headlights, all the software included in the body control module (BCM) that controls the headlights may be updated.

As such, updating all the software of the electrical device to update the software related to the specific function of the electrical device increases the time for updating the software of the electrical device. In addition, the driver waits for an update of the software.

### SUMMARY

The present disclosure relates to a vehicle and an electrical device for a vehicle. Particular embodiments relate to a vehicle and an electrical device for a vehicle capable of updating software of a vehicle.

In view of the above, an embodiment of the present disclosure provides a vehicle and an electrical device for a vehicle that can reduce the time for updating the software of the electrical device.

One embodiment of the present disclosure provides a vehicle and an electrical device for a vehicle capable of selectively updating software to be updated.

One embodiment of the present disclosure provides a vehicle and an electrical device for a vehicle that can reduce the cost for data transmission wirelessly.

In accordance with an embodiment of the present disclosure, a vehicle includes at least one electrical device, and a communication device configured to communicate with a server, receive a software update data, and provide the software update data to the at least one electrical device, and the electrical device includes a communication interface configured to receive the software update data from the communication device, a memory configured to store a software component, and a processor configured to update the software component using the software update data, wherein a storage area in which the software component may be stored and a reserved area allocated to the software component are alternately arranged in the memory.

The electrical device may include a software allocator configured to control an update of the software component stored in the memory.

The software allocator may store the software update data in the storage area and the reserved area in the memory.

The software allocator may store a memory address of the storage area and a memory address of the reserved area.

In the memory, a first storage area in which a first software component is stored, a first reserved area allocated to the first software component, a second storage area in which a second software component is stored, and a second reserved area allocated to the second software component may be arranged in order.

The software allocator may store a first software update data of the first software component in the first storage area and the first reserved area, and may store a second software update data of the second software component in the second storage area and the second reserved area.

In accordance with an embodiment of the present disclosure, an electrical device for a vehicle includes a communication interface configured to receive a software update data, a memory configured to store a software component, and a processor configured to update the software component by using the software update data, wherein a storage area in which the software component may be stored and a reserved area allocated to the software component may be alternately arranged in the memory.

The electrical device further comprises a software allocator configured to control an update of the software component stored in the memory.

The software allocator may store the software update data in the storage area and the reserved area in the memory.

The software allocator may store a memory address of the storage area and a memory address of the reserved area.

In the memory, a first storage area in which a first software component is stored, a first reserved area allocated to the first software component, a second storage area in which a second software component is stored, and a second reserved area allocated to the second software component may be arranged in order.

The software allocator may store a first software update data of the first software component in the first storage area and the first reserved area, and may store a second software update data of the second software component in the second storage area and the second reserved area. A software update data is not limited to the first software update data of the first software component and the second software update data of the second software component.

In accordance with an aspect of an embodiment, a vehicle includes at least one electrical device, and a communication device configured to communicate with a server, receive a software update data, and provide the software update data to the at least one electrical device, and the electrical device includes a communication interface configured to receive the software update data from the communication device, a memory configured to store software component, and a processor configured to update the software group using the software update data, wherein a storage area in which the software group is stored and a reserved area allocated to the software group may be alternately arranged in the memory, and the software group may include a plurality of software components.

The electrical device may include a software allocator configured to control an update of the plurality of software components included in the software group stored in the memory.

The software allocator may store the software update data in the storage area and the reserved area in the memory.

In the memory, a first storage area in which a first software group is stored, a second storage area in which a second software group is stored, and a second reserved area in which the second software group is stored are arranged in order, and the first software group may include a plurality of a first software component, and the second software group may include a plurality of a second software component.

The software allocator may store a first software update data of the plurality of first software components in the first storage area and the first reserved area, and may store a second software update data of the plurality of second software components in the second storage area and the second reserved area.

### BRIEF DESCRIPTION OF THE DRAWINGS

These and/or other aspects of the invention will become apparent and more readily appreciated from the following description of embodiments, taken in conjunction with the accompanying drawings, in which:

FIG. 1 illustrates a vehicle and a server device according to an embodiment;

FIG. 2 and FIG. 3 illustrate a configuration of a vehicle according to an embodiment;

FIG. 4 illustrates an example of updating an electrical device of a vehicle according to an embodiment;

FIGS. 5A-5C show a memory management and software update of a vehicle according to the prior art;

FIG. 6 and FIGS. 7A-7C illustrate an example of memory management and software update of a vehicle, according to an embodiment; and

FIG. 8 illustrates another example of memory management and software update of a vehicle, according to an embodiment.

### DETAILED DESCRIPTION OF ILLUSTRATIVE EMBODIMENTS

Hereinafter, embodiments of the present disclosure will be described in detail with reference to the accompanying drawings.

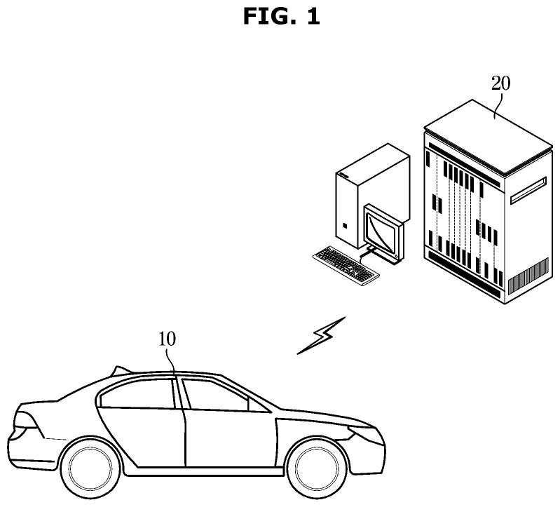

FIG. 1 illustrates a vehicle and a server device according to an embodiment.

As shown in FIG. 1, vehicle 10 may communicate wirelessly with server device 20.

The vehicle 10 may drive on roads or tracks using fossil fuels, electricity, and the like as a power source.

The vehicle 10 may be equipped with a plurality of electrical devices that provide convenience and safety to the driver. For example, the vehicle 10 may be provided with convenience devices such as an audio/video/navigation (AVN) device and a heating ventilating air conditioning (HVAC) device. In addition, the vehicle 10 includes a traveling device related to the driving of the vehicle such as an engine management system (EMS), a transmission control unit (TCU), electronic stability control (ESC), and motor driven power steering (MDPS).

The plurality of electrical devices installed in the vehicle 10 may each include a sensor, an actuator, and a controller (Electronic Control Unit, ECU). The sensor may acquire environmental information and/or operation information of the vehicle 10, and the actuator may drive the vehicle 10. The controller may control the actuator based on the output of the sensor. The vehicle 10 is a device directly related to the safety and life of the driver and/or passenger, and requires the integrity of the operation of the devices (mechanical devices and electrical devices) included in the vehicle 10. Small errors in electrical devices can greatly threaten the safety and life of the driver and/or passengers.

However, unexpected situations occur frequently while driving the vehicle 10, and situations that the designer did not anticipate may occur. As such, the mechanical devices and/or electrical devices of the vehicle 10 may malfunction in unexpected situations. An update of the vehicle 10 may be made to prevent, compensate for or correct malfunctions of the mechanical devices and/or electrical devices of the vehicle 10.

The electrical devices of the vehicle 10 may be equipped with hardware and software for controlling each part of the vehicle 10. The hardware may include a sensor, an actuator, a processor, a memory, etc. installed in each of the electrical devices, and the software may include a program and/or data stored in a processor and/or memory.

The update of the vehicle 10 may include an update of the software. For example, updating the software may include replacing the programs and/or data installed in the controller with new programs and/or new data.

Through this software update, the vehicle 10 can compensate for, correct or prevent hardware and/or existing software, and add new functions.

The vehicle 10 may communicate with the server device 20 for a software update, and receive a program and data (hereinafter referred to as “software update data”) for a software update from the server device 20. For example, the vehicle 10 may receive software update data for updating software installed in various electrical devices.

The server device 20 can communicate with the vehicle 10. The server device 20 may store software update data of the vehicle 10 and transmit the software update data to the vehicle 10 while communicating with the vehicle 10.

The vehicle 10 may update software of the vehicle 10 based on software update data received from the server device 20.

Hereinafter, the configuration and operation of the vehicle 10 and the server device 20 will be described in detail.

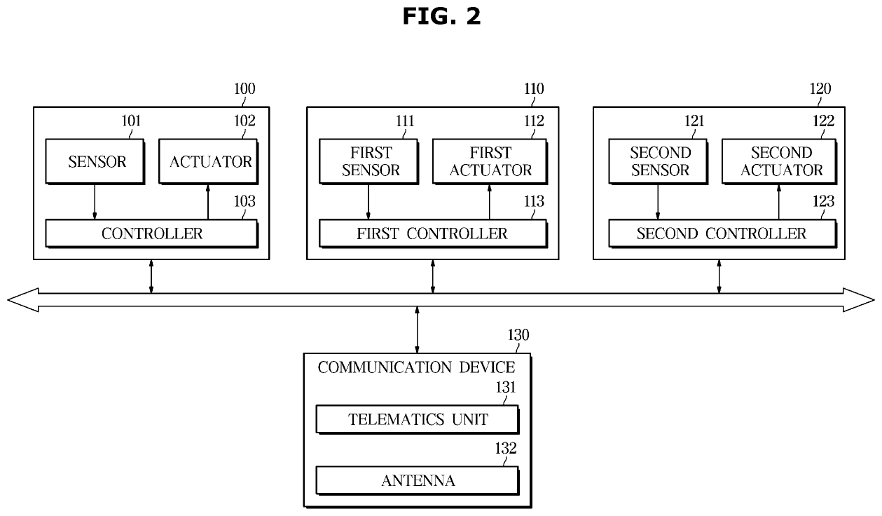

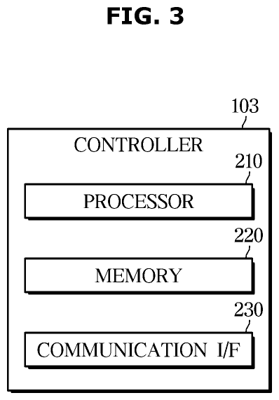

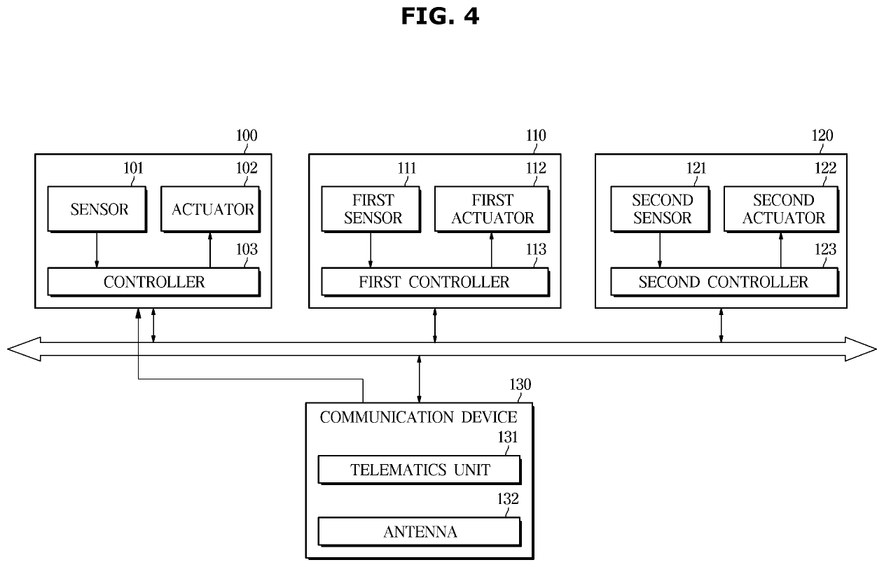

FIG. 2 and FIG. 3 illustrate a configuration of a vehicle according to an embodiment. FIG. 4 illustrates an example of updating an electrical device of a vehicle according to an embodiment.

The vehicle 10 includes a plurality of electrical devices. For example, the vehicle 10 may include a communication device 130 for communicating with the server device 20 as shown in FIGS. 2, 3 and 4. The vehicle 10 may also include an electrical device 100, a first electrical device 110, and a second electrical device 120. The electrical device 100, the first electrical device 110, and the second electrical device 120 may be different electrical devices. For example, the electrical device 100, the first electrical device 110 and the second electrical device 120 may respectively be an engine management system, transmission control unit, electronic drive stabilization control, motor driven power steering, air conditioning unit, door lock control unit, airbag control unit, audio/video/navigation device, cluster, or the like.

The communication device 130, the electrical device 100, the first electrical device no and the second electrical device 120 are connected via a vehicle communication network. For example, the communication device 130, the electrical device 100, the first electrical device 110, and the second electrical device 120 can communicate through Ethernet, MOST (Media Oriented Systems Transport), Flexray, CAN (Controller Area Network), and/or LIN (Local Interconnect Network).

The electrical device 100 may include a sensor 101, an actuator 102, and a controller 103.

The sensor 101 may collect environmental information and/or operation information of the vehicle 10. For example, the sensor 101 may be a temperature sensor, an illuminance sensor, a timer, and the like, and may collect environmental information such as ambient temperature, illuminance, and time. In addition, the sensor 101 may collect traffic information such as distance information from other vehicles.

The sensor 101 may be an accelerator pedal sensor, a brake pedal sensor, a speed sensor, a steering angle sensor, an acceleration sensor, a yaw sensor, a camera, a radar, or the like. The sensor 101 may collect information related to driving of the vehicle 10, such as the driver's acceleration behavior, the driver's braking behavior, the vehicle 10's driving speed, the steering angle, the acceleration, the yaw rate, the image in front of the vehicle 10, and any obstacle in front of the vehicle 10.

The sensor 101 is electrically connected to the controller 103 and may transmit sensing data to the controller 103.

The actuator 102 is electrically connected to the controller 103 and can operate mechanically or electrically in response to a control command of the controller 103.

For example, the actuator 102 may be a valve, a motor, or the like. The actuator 102 may close or open the flow path in response to the control command of the controller 103, and may also generate the kinetic force (rotation) in response to the control command of the controller 103.

The controller 103 is connected to the sensor 101 and the actuator 102. The controller 103 may process the sensing data of the sensor 101 and generate control data for controlling the actuator 102. For example, the controller 103 may receive the accelerator pedal displacement from the accelerator pedal sensor and generate control data for controlling the opening degree of the throttle valve of the engine in response to the accelerator pedal displacement.

The controller 103 is configured to communicate with a communication interface 230 to communicate with the communication device 130, a memory 220 capable of storing software for processing sensing data and generating control data, and sensing data according to software stored in the memory 220, and a processor 210 for processing and generating control data.

The communication interface 230 includes a CAN transceiver (not shown) that receives a communication signal from other electrical devices of the vehicle 10 through the vehicle communication network NT, and transmits the communication signal to the other electrical devices of the vehicle 10 and a communication controller for controlling the operation of the CAN transceiver.

The CAN transceiver may receive software update data at the communication device 130 via the vehicle communication network NT.

The memory 220 may provide a program and/or data to the processor 210 according to the control signal of the memory 220 of the processor 210. For example, the memory 220 may temporarily store sensing data sensed by the sensor 101 and control data to be output to the actuator 102.

The memory 220 may include volatile memory such as static random access memory (S-RAM) and dynamic random access memory (D-RAM), read only memory (ROM), and a nonvolatile memory such as erasable programmable read only memory (EPROM) and EEPROM (Electrically Erasable Programmable Read Only Memory).

Software stored in nonvolatile memory may be loaded into volatile memory. For example, software stored in nonvolatile memory may be loaded into volatile memory each time the vehicle 10 is turned on, or may be loaded into volatile memory upon initial startup of the vehicle 10.

The processor 210 may process data according to a program provided from the memory 220 and generate a control signal according to the processing result. For example, the sensing data sensed by the sensor 101 may be processed, and control data to be output to the actuator 102 may be generated.

The processor 210 may load software stored in the nonvolatile memory into the volatile memory, and process sensing data and generate control data according to the software loaded into the volatile memory.

The processor 210 may include various logic circuits and arithmetic circuits.

The processor 210 and the memory 220 may be integrally implemented as a single chip, or may be implemented as separate chips.

The controller 103 may receive data for updating software from the communication device 130 and update the software based on the software update data.

Software stored in the nonvolatile memory may be updated by software update data received from the server device 20. Specifically, by updating the software, software previously stored in the nonvolatile memory may be overwritten with software update data received from the server device 20.

The first and second electrical devices 110 and 120 include the first and second sensors 111 and 121, the first and second actuators 112 and 122, and the first and second controllers 113 and 123, respectively.

Each of the first and second electrical devices 110 and 120 may perform a different function from the electrical device 100.

The electrical device 100 and the first and second electrical devices 110 and 120 are merely examples of the electrical devices included in the vehicle 10, and the electrical devices included in the vehicle 10 are not limited to those shown in FIGS. 2 and 3.

The communication device 130 is connected to the electrical device 100, the first electrical device 110 and the second electrical device 120 through the vehicle communication network NT.

The communication device 130 includes a telematics unit 131 and an antenna 132. The telematics unit 131 may output the transmission signal to the antenna 132 to transmit the transmission signal to the server device 20.

In addition, the telematics unit 131 may receive a received signal from the antenna 132 and may demodulate the received signal. The received signal may include, for example, software update data, and the telematics unit 131 may demodulate the received signal into software update data. In addition, the telematics unit 131 may transmit software update data to the electrical device 100 through the vehicle communication network NT as shown in FIG. 4.

The antenna 132 may radiate radio waves into free space and receive radio waves from the free space.

The antenna 132 may receive a transmission signal from the telematics unit 131, and may emit free space for radio waves corresponding to the transmission signal. In addition, the antenna 132 may receive a radio wave from a free space and transmit a received signal corresponding to the received radio wave to the telematics unit 131.

As such, the communication device 130 may wirelessly receive the received signal from the server device 20 and transmit the software update data included in the received signal to the electrical device 100 and the first and second electrical devices 110 and 120.

As such, the vehicle 10 may receive software update data from the server device 20. In addition, in response to receiving the software update data, the vehicle 10 may update the software of each electrical device.

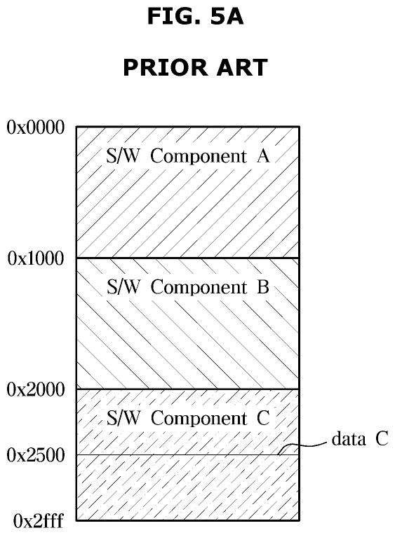

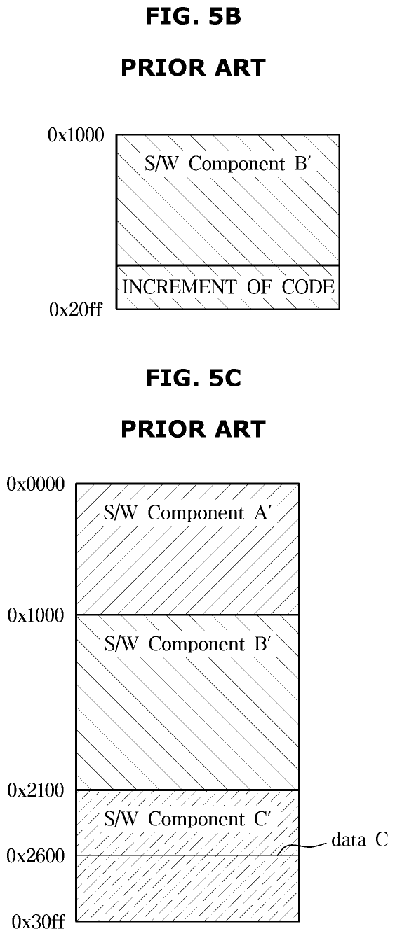

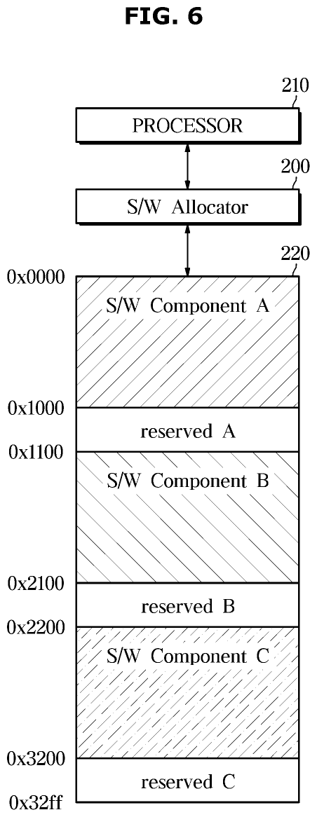

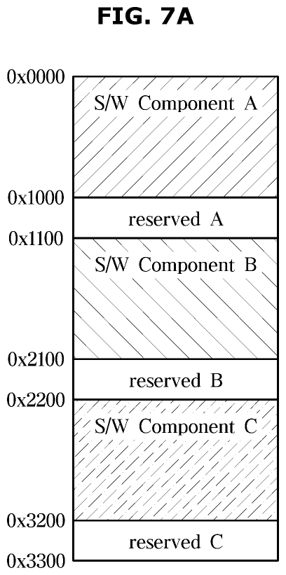

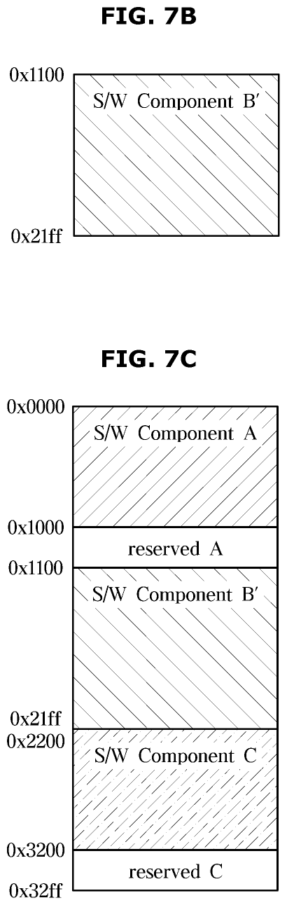

FIGS. 5A-5C show a memory management and software update of a vehicle according to the prior art. FIG. 6 and FIGS. 7A-7C illustrate an example of memory management and software update of a vehicle, according to an embodiment.

Conventional vehicles have stored software continuously in memory. For example, as shown in FIG. 5A, the software component A is stored between the memory address “0x0000” and the memory address “0x0fff”, and the software component B is stored between the memory address “0x0000” and the memory address “0x1fff”. In addition, the software component C was stored between the memory address “0x2000” and the memory address “0x2fff”.

At this time, the software component A may perform different functions from the software component B and the software component C, and the software component B may perform different functions from the software component C.

In addition, software component A may refer to data contained in software component B and software component C based on the address of the memory, and software component B may refer to data included in software component C and software component A based on the address of the memory. In addition, software component C may refer to data contained in software component A and software component B based on the address of the memory.

For example, software component A and software component B may refer to data C included in software component C, which may be stored at memory address “0x2500”.

At this time, when the memory address of the software component C is changed, both the code of the software component A and the software component B that references the data of the software component C should be changed. If the memory address of software component C changes, the memory address of data C also changes, and the code of software component A and software component B that references data C must also change.

For example, as shown in FIG. 5B, the software component B may be updated to the software component B′. The code of software component B′ may be longer than the code of software component B, and software component B′ may occupy memory address “0x20ff” in memory address “0x1000”.

Since software component B′ occupies memory address “0x20ff” at memory address “0x1000”, software component C must be updated with software component C′ stored between memory address “0x2100” and memory address “0x30ff”. In addition, since the software component C′ is stored between the memory address “0x2100” and the memory address “0x30ff”, the memory address of the data C is also changed from “0x2500” to “0x2600”. Thus, software component A referring to data C must also be updated to software component A′ referring to data C at memory address “0x2600”.

In order to update software component B to software component B′, software component A and software component C must be updated to software component A′ and software component C′, respectively.

As such, in the case of a conventional vehicle, updating some of the software stored in the memory of the electrical device had to update all the software stored in the memory of the electrical device.

According to an exemplary embodiment, the vehicle 10 may discontinuously store software in the memory 220. For example, as shown in FIG. 6, software component A, software component B, and software component C may be discontinuously stored in the memory 220.

Specifically, software component A may be stored between memory address “0x0000” and memory address “0x0fff”, and software component B may be stored between memory address “0x1100” and memory address “0x20ff”. A reserved area A may be provided in the memory address between “0x1000” and the memory address “0x10ff”, which is between the software component A and the software component B. The reserved area A is prepared in preparation for the update of the software component A. When the software component A is updated to the software component A′, a part of the software component A′ may be stored in the reserved area A.

Software component B may be stored between memory address “0x1100” and memory address “0x20ff”, and software component C may be stored between memory address “0x2200” and memory address “0x31ff”. A reserved area B (reserved region B) may be provided at the memory address between “0x2100” and “0x21ff”, which is between the software component A and the software component B. The reserved area B is prepared in preparation for the update of the software component B. When the software component B is updated to the software component B′, a part of the software component B′ may be stored in the reserved area B.

The software component C may be stored between the memory address “0x2200” and the memory address “0x31ff” and the reserved area C (reserved region C) may be provided between the memory address “0x3200” and “0x32ff”. The reserved area C is prepared in preparation for the update of the software component C. When the software component C is updated to the software component C′, a part of the software component C′ may be stored in the reserved area C.

In the memory 220, a storage area in which a software component is stored and a reserved area allocated to the software component may be alternately provided. The memory 220 stores a storage area A in which software component A is stored, a reserved area A allocated to software component A, a storage area B in which software component B is stored, a reserved area B allocated to software component B, and a storage area C in which software component C is stored, and a reserved area C allocated to the software component C.

As such, since a reserved area is provided between the software components, the vehicle 10 may selectively update the software components that need to be updated among the software components stored in the memory 220.

For example, as shown in FIG. 7A, a software component A, a software component B, and a software component C may be stored in the memory 220 of the vehicle 10. In addition, reserved area A may be provided between software component A and software component B, reserved area B may be provided between software component B and software component C, and reserved area C may be provided below software component C.

In this case, as illustrated in FIG. 7B, the software component B may be updated to the software component B′. The code of software component B′ may be longer than the code of software component B, and software component B′ may occupy the memory address “0x1100” through the memory address “0x21ff”.

Since software component B′ occupies the memory address between “0x21ff” to “0x1100” and reserved area B is reserved from memory addresses “0x2100” to “0x21ff”, the updated software component B′ can be stored in the area in which existing software component B is stored and in the reserved area B.

At this time, since the software component C is stored between the memory address “0x2200” and the memory address “0x31ff”, the software component B′ does not invade the storage area of the software component C as shown in FIG. 7C. Thus, even if software component B is updated to software component B′, there is no effect on software component C. In other words, software component C may not be updated. In addition, software component A may also not be updated.

As such, the electrical device 100 of the vehicle 10 may include a software allocator 200 to provide a reserved area between the software components, to execute the software components, and to update the software components.

The software allocator 200 may be provided between the memory 220 in which the software components are stored and the processor 210 in which the software components are executed. The software allocator 200 may be hardware installed between the processor 210 and the memory 220 or software stored in the memory 220.

The software allocator 200 manages a storage area (or storage space) of the memory 220 and may provide software components stored in the memory 220 to the processor 210 in response to a loading command of the processor 210. In addition, the software allocator 200 may manage updates of software components stored in the memory 220.

The software allocator 200 can manage software components. The software allocator 200 may store a software allocation table including identification information of each of the software components stored in the memory 220, a memory address of each of the software components, and a memory address of a reserved area allocated to each of the software components.

The software allocator 200 may load a software component into the processor 210 at a memory address at which a specific software component is stored by referring to a software allocation table.

In addition, the software allocator 200 may update a specific software component with reference to the software allocation table. In detail, the software allocator 200 may store software update data at a memory address where a software component to be updated is stored and a memory address of a reserved area allocated to the software component to be updated.

As such, the software allocator 200 may build a static architecture by assigning software components to the physical storage space of the memory 220.

By providing a reserved area of the software component together with a storage area of the software component on the memory 220, the software may be updated in units of software components.

The software allocator 200 manages the physical storage space of the memory 220 and manages the updating of software components.

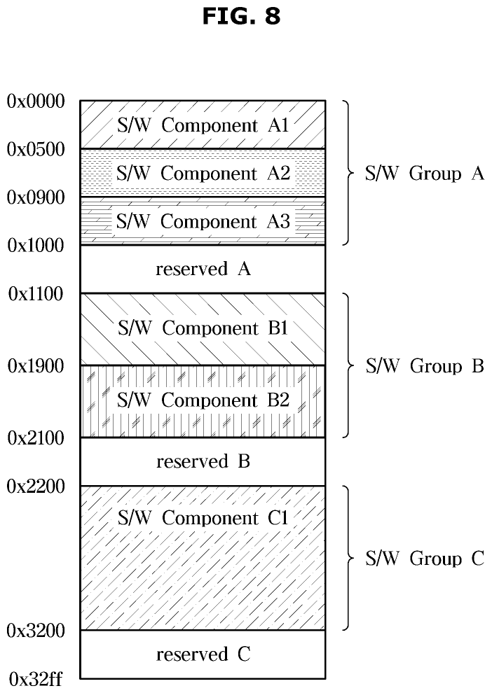

FIG. 8 illustrates another example of memory management and software update of a vehicle, according to an embodiment.

According to an exemplary embodiment, the vehicle 10 may discontinuously store software in the memory 220. For example, as shown in FIG. 8, the software group A, the software group B, and the software group C may be discontinuously stored in the memory 220.

A software group can be a bundle of one or more software components. Software group A may include software component A1, software component A2 and software component A3. Software group B may include software component B1 and software component B2. Software group C may also include software component C1.

Reserved areas may be provided between software groups. For example, reserved area A may be provided between software group A and software group B, and reserved area B may be provided between software group B and software group C. In addition, a reserved area C may be provided under the software group C.

As such, one reserved area may be allocated to a software group (one or more software components).

By allocating a reserved area to one or more software components, the storage space of the memory 220 can be managed more efficiently.

Prior to the update, the software component is not stored in the reserved area and the reserved area is left blank. If the number of software components increases, the number of reserved areas also increases, thereby increasing the proportion of reserved areas of the memory 220. In other words, due to an increase in the reserved area, an empty space of the memory 220 may increase, and a storage space of the memory 220 may not be efficiently used.

By allocating a reserved area to one or a plurality of software components, the ratio of the reserved area in the entire storage space of the memory 220 can be maintained at a constant level, and the storage space of the memory 220 can be managed more efficiently.

The software group may occupy a storage area of a predetermined size or more. A software group may consist of one or more software components that perform similar functions, or may consist of any one or more software components. In addition, one or more software components included in the software group may occupy a storage area of a predetermined size or more.

When any one of one or a plurality of software components included in the software group is updated, all the software components included in the software group may be updated.

For example, if software component A2 belonging to software group A is updated, all of software component A1, software component A2 and software component A3 belonging to software group A may be updated. In addition, when software component B2 belonging to software group B is updated, both software component B1 and software component B2 belonging to software group B may be updated.

When one or a plurality of software components of the software group are updated, the software update data may be stored in an area in which the software group is stored and in a reserved area allocated to the software group.

The size of the software group may be set in consideration of minimizing the number of times of transmitting and receiving software update data between the server device 20 and the vehicle 10 and minimizing a system buffer temporarily storing the software update data.

For example, the size of the software group may be set to n times or 1/n of communication throughput based on the size of data that can be received when performing wireless communication one time. If the communication throughput is greater than or equal to the size of the system buffer, the size of the software group may be set to 1/n of the communication throughput. Also, if the communication throughput is smaller than the system buffer, the size of the software group can be set to n times the communication throughput.

In accordance with an aspect of embodiments of the present disclosure, it is possible to provide an electrical device for a vehicle that can reduce the time for updating the software of the electrical device.

In accordance with an aspect of embodiments of the present disclosure, it is possible to provide a vehicle and an electrical device for a vehicle capable of selectively updating software to be updated.

In accordance with an aspect of embodiments of the present disclosure, it is possible to provide a vehicle and an electrical device for a vehicle that can reduce the cost for data transmission wirelessly.

What is claimed is:

1. A vehicle comprising:
an electrical device; and
a communication device configured to communicate with a server, to receive a software update data, and to provide the software update data to the electrical device;
wherein the electrical device includes a communication interface configured to receive the software update data from the communication device, a memory configured to store a software component, and a processor configured to update the software component using the software update data; and
wherein a storage area in which the software component is stored and a reserved area allocated to the software component are alternately arranged in the memory.

2. The vehicle according to claim 1, wherein the electrical device includes a software allocator configured to control an update of the software component stored in the memory.

3. The vehicle according to claim 2, wherein the software allocator is configured to store the software update data in the storage area and the reserved area in the memory.

4. The vehicle according to claim 3, wherein the software allocator is configured to store a memory address of the storage area and a memory address of the reserved area.

5. The vehicle according to claim 2, wherein a first storage area in which a first software component is stored, a first reserved area allocated to the first software component, a second storage area in which a second software component is stored, and a second reserved area allocated to the second software component are arranged in order in the memory.

6. The vehicle according to claim 5, wherein the software allocator is configured to store a first software update data of the first software component in the first storage area and the first reserved area, and store a second software update data of the second software component in the second storage area and the second reserved area.

7. An electrical device for a vehicle comprising:
a communication interface configured to receive a software update data;
a memory configured to store a software component; and
a processor configured to update the software component by using the software update data,
wherein a storage area in which the software component is stored and a reserved area allocated to the software component are alternately arranged in the memory.

8. The electrical device according to claim 7, further comprising a software allocator configured to control an update of the software component stored in the memory.

9. The electrical device according to claim 8, wherein the software allocator is configured to store the software update data in the storage area and the reserved area in the memory.

10. The electrical device according to claim 9, wherein the software allocator is configured to store a memory address of the storage area and a memory address of the reserved area.

11. The electrical device according to claim 8, wherein a first storage area in which a first software component is stored, a first reserved area allocated to the first software component, a second storage area in which a second software component is stored, and a second reserved area allocated to the second software component are arranged in order in the memory.

12. The electrical device according to claim 11, wherein the software allocator is configured to store a first software update data of the first software component in the first storage area and the first reserved area, and store a second software update data of the second software component in the second storage area and the second reserved area.

13. A vehicle comprising:
at least one electrical device; and
a communication device configured to communicate with a server, receive a software update data, and provide the software update data to the at least one electrical device;
wherein the electrical device includes a communication interface configured to receive the software update data from the communication device, a memory configured to store a software group, and a processor configured to update the software group using the software update data;
wherein a storage area in which the software group is stored and a reserved area allocated to the software group are alternately arranged in the memory; and
wherein the software group includes a plurality of software components.

14. The vehicle according to claim 13, wherein the electrical device includes a software allocator configured to control an update of the plurality of software components included in the software group stored in the memory.

15. The vehicle according to claim 14, wherein the software allocator is configured to store the software update data in the storage area and the reserved area in the memory.

16. The vehicle according to claim 15, wherein the software allocator is configured to store a memory address of the storage area and a memory address of the reserved area.

17. The vehicle according to claim 14, wherein:
a first storage area in which a first software group is stored, a first reserved area in which the first software group is stored, a second storage area in which a second software group is stored, and a second reserved area in which the second software group is stored are arranged in order in the memory; and
the first software group includes a plurality of a first software component, and the second software group includes a plurality of a second software component.

18. The vehicle according to claim 17, wherein the software allocator is configured to store a first software update data of the plurality of the first software components in the first storage area and the first reserved area, and store a second software update data of the plurality of the second software components in the second storage area and the second reserved area.

19. The vehicle according to claim 13, wherein the communication device comprises:
a telematics unit; and
an antenna.
